(19) United States
(12) Patent Application Publication
(10) Pub. No.: US 2016/0202834 A1
(43) Pub. Date: Jul. 14, 2016

(54) UNLOCKING METHOD AND TERMINAL DEVICE USING THE SAME

(71) Applicant: Xiaomi Inc., Beijing (CN)

(72) Inventors: Zhongsheng JIANG, Beijing (CN); Kun YANG, Beijing (CN); Jun TAO, Beijing (CN)

(21) Appl. No.: 14/932,991

(22) Filed: Nov. 5, 2015

(30) Foreign Application Priority Data
Jan. 13, 2015 (CN) 201510017639.5
Jan. 27, 2015 (CN) 201510041290.9

(51) Int. Cl. G06F 3/041; G06F 3/01; G06F 3/0488

(52) U.S. Cl. CPC G06F 3/0416; G06F 3/0488; G06F 3/011; G06F 2203/04106

(57) ABSTRACT

An unlocking method and a terminal device using the same are provided. The method includes: collecting a signal at an edge of a touch screen of the terminal device; judging whether the terminal device is held by a user according to the collected signal; and if the terminal device is held by the user and the terminal device is in a sleeping mode, unlocking the terminal device. The method allows the user to unlock the terminal device after holding the terminal device, which improves the convenience and the intelligence of unlocking by the user.

### CROSS-REFERENCE TO RELATED APPLICATIONS

This application is based upon and claims priority to Chinese Patent Application No. 201510017639.5, filed Jan. 13, 2015 and Chinese Patent Application No. 201510041290.9, filed Jan. 27, 2015, the entire contents of which are incorporated herein by reference.

### TECHNICAL FIELD

The present disclosure relates to the technical field of electronic devices, and more particularly, to an unlocking method and a terminal device using the same.

### BACKGROUND

With the continuing increase of functions of terminal devices, more and more new functions of the terminal devices bring more convenience to users.

The inventors have noted that as a basic unit for human-computer interaction, the touch screen might be inadvertently touched. Since the sensitivity of the touch screen is high, convenient operations are brought to the user, however, at the same time, the probability of inadvertent touch greatly increases. For example, when the mobile phone is put into the pocket or the bag, various unwanted responses may easily occur. Even when the mobile phone is in a sleeping mode, the mobile phone may be activated mistakenly due to an inadvertent touch. Since the response of the touch screen to a touch event depends on a touch signal intensity, using the same touch signal intensity as a response threshold of the touch event might cause that the sensitivities of the touch screen in different operational environments are inconsistent.

### SUMMARY

The embodiments of the present disclosure provide an unlocking method and a terminal device using the same.

According to a first aspect of embodiments of the present disclosure, there is provided a method for unlocking a terminal device, including: collecting a signal at an edge of a touch screen of the terminal device; judging whether the terminal device is held by a user according to the collected signal; and if the terminal device is held by the user and the terminal device is in a sleeping mode, unlocking the terminal device.

According to a second aspect of embodiments of the present disclosure, there is provided a terminal device, including: a touch screen; a processor; and a memory for storing instructions executable by the processor; wherein the processor is configured to execute instructions for: collecting a signal at an edge of the touch screen of the terminal device; judging whether the terminal device is held by a user according to the collected signal; and if the terminal device is held by the user and the terminal device is in a sleeping mode, unlocking the terminal device.

According to a third aspect of the embodiments of the present disclosure, there is provided a non-transitory readable storage medium including instructions, executable by a processor in a terminal device, for performing a method of unlocking the terminal device, the method including: collecting a signal at an edge of a touch screen of the terminal device; judging whether the terminal device is held by a user according to the collected signal; and if the terminal device is held by the user and the terminal device is in a sleeping mode, unlocking the terminal device.

The embodiments of the present disclosure may, in part, include the following advantageous effects: signals at edges of the touch screen of the terminal device are collected, whether the terminal device is held by the user is judged according to the collected signals, and when the terminal device is held by the user and the terminal device is in the sleeping state, the terminal device is unlocked; in this way, the user can unlock the terminal device after holding the terminal device, thereby the convenience and the intelligence of unlocking by the user is improved.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 illustrates a flow chart of an unlocking method, according to one exemplary embodiment of the present disclosure.

FIG. 2 illustrates a schematic diagram of providing a self-contained sensor at an edge of a touch screen, according to one exemplary embodiment of the present disclosure.

FIG. 3 illustrates a signal collected when a user holds a terminal device by his/her left hand, according to one exemplary embodiment of the present disclosure.

FIG. 4 illustrates a block diagram of an unlocking apparatus, according to one exemplary embodiment of the present disclosure.

FIG. 5 illustrates a block diagram of another unlocking apparatus, according to one exemplary embodiment of the present disclosure.

FIG. 6 illustrates a block diagram of further another unlocking apparatus, according to one exemplary embodiment of the present disclosure.

FIG. 7 illustrates a block diagram of a terminal device using the unlocking method, according to one exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with some aspects related to the invention as recited in the appended claims.

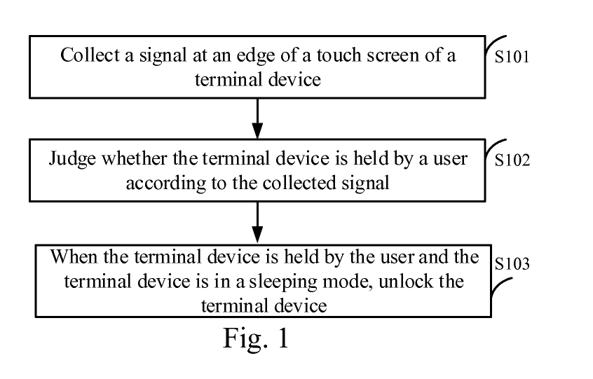

FIG. 1 illustrates a flow chart of an unlocking method, according to one exemplary embodiment. As shown in FIG. 1, the above unlocking method is applicable to terminal devices, such as mobile phones and tablet computers. The method includes the following steps.

In step S101, a signal at an edge of a touch screen of a terminal device is collected.

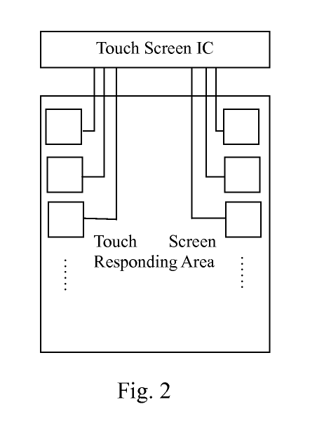

For instance, in the present disclosure, a self-containing solution is adopted at an edge area of the touch screen, thereby a high signal to noise ratio (SNR) can be provided; and signals are collected from multiple channels, thereby the signals of holding the edge by hand are collected. As shown in FIG. 2, a plurality of self-containing sensors are provided at left and right edges of the touch screen. In order to further improve SNR in the edge area, a shielding layer may be further added below these edge self-containing sensors for shielding the noise interference from the below display screen. The need of the shielding layer depends on whether the actual SNR satisfies requirements. Two rectangular shielding layers may be disposed below the self-containing sensors located at the left and right sides, or the shielding layer may be disposed at the entire screen, so as to shield the noise interference from the below display screen.

In step S102, whether the terminal device is held by a user is judged according to the collected signal.

In one embodiment, the above step S102 may include the following steps A1-A2.

In step A1, whether a first signal and a second signal are collected at one side edge of the touch screen of the terminal device and at least a third signal is collected at the other side edge of the touch screen of the terminal device are judged, wherein the first signal is greater than the second signal, and the first signal is greater than the third signal.

In step A2, if the first, second and third signals are collected, it is determined that the terminal device is held by a user.

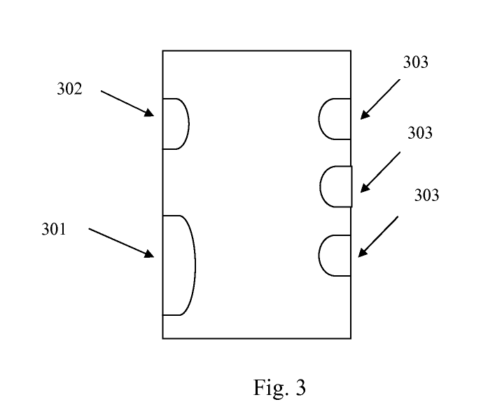

For instance, as shown in FIG. 3, one side of the touch screen corresponds to touch signals of a thumb and a palm of the hand holding the terminal device, the touch signals corresponding to the second and first signals respectively; and the other side corresponds to one to four touch signals of other fingers of the hand holding the terminal device, these touch signals corresponding to the third signal. FIG. 3 illustrates the condition in which the left hand holds the terminal device. The signals collected at the left side of the touch screen are a palm touch signal (i.e., the first signal 301) and a thumb signal (i.e., the second signal 302); and the signal at the right side of the touch screen is identified to be touch signals of other fingers of the left hand (i.e., the third signal 303).

Through the above signals, it may be judged not only whether the user holds the terminal device, but also the user holds the terminal device by his/her left hand or right hand. When the signals at the left side of the touch screen are the first and second signals and the signal at the right side is the third signal, it is judged that the terminal device is held by the left hand; and when the signals at the right side of the touch screen are the first and second signals and the signal at the left side is the third signal, it is judged that the terminal device is held by the right hand.

In step S103, when the terminal device is held by the user and the terminal device is in a sleeping mode, the terminal device is unlocked.

In one embodiment, the above step S102 may include: judging whether the terminal device is held by a left hand or a right hand of the user according to the collected signals. The above step S103 may include: when the terminal device is held by the left hand or the right hand of the user and the terminal device is in a sleeping mode, unlocking the terminal device.

For instance, based on the above signals, when the terminal device is in a sleeping mode, the touch screen is turned on and a scan of the edge sensor is started. When the user holds the terminal device, the touch screen makes a response and judges whether the terminal device is held by a left hand or a right hand. If the terminal device is held by corresponding left or right hand, an interrupt is sent to a system in the terminal device to awake the terminal device and perform an unlocking operation; and if it is judged that the terminal device is not held by corresponding left or right hand, the system of the terminal device remains sleeping without the unlocking operation.

In this way, the user may awake the system and unlock the terminal device without any additional operation. The holding by hand is identified by utilizing the current touch screen without any additional component.

In one embodiment, the method in the present disclosure may further include: when the terminal device is held by the user and a touch event is occurred on the touch screen of the terminal device, responding to the touch event.

For example, according to the above signals, the function of judging whether the edge of the terminal device is held by hand is started. When a touch event occurs on the touch screen, whether the terminal device is held by a user is detected at first. If the terminal device is held by the user, no matter by right hand or left hand, the system of the terminal device responds to this touch event. If the terminal device is not held by the user, the system of the terminal device ignores this touch event.

In one embodiment, the method in the present disclosure may further include the following steps B1-B2.

In step B1, when the terminal device is held by a user and a touch event occurs on the touch screen of the terminal device, the touch event is responded to by using a first touch event response threshold.

In step B2, when the terminal device is not held by the user and a touch event occurs on the touch screen of the terminal device, the touch event is responded to by using a second touch event response threshold.

The first touch event response threshold is greater than the second touch event response threshold.

For instance, according to the above signals, the function of judging whether the edge of the terminal device is held by hand is started. When a touch event occurs on the touch screen, whether the terminal device is held by a user is judged at first. If the terminal device is held by the user, an intensity of the touch signal will be relatively high, thus a relatively high first touch event response threshold is used to reduce the sensitivity. If the terminal device is not held by the user, the intensity of the signal will be relatively low, thus a relatively low second touch event response threshold is used to increase the sensitivity.

In this way, the touch screen has a consistent touch sensitivity under different operating environments or operating modes.

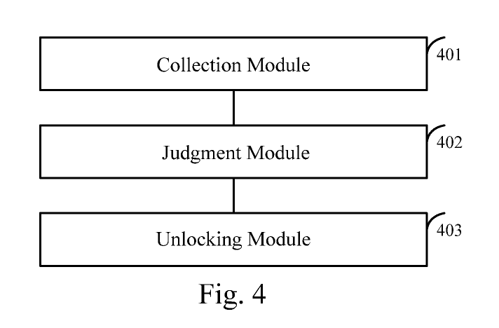

FIG. 4 illustrates a block diagram of an unlocking apparatus, according to one exemplary embodiment of the present disclosure. As shown in FIG. 4, the above unlocking apparatus is applicable to terminal devices, such as mobile phones and tablet computers. The unlocking apparatus includes a collection module 401, a judgment module 402, and an unlocking module 403.

The collection module 401 is configured to collect a signal at an edge of a touch screen of a terminal device.

The judgment module 402 is configured to judge whether the terminal device is held by a user according to the collected signal.

The unlocking module 403 is configured to unlock the terminal device when the terminal device is held by the user and the terminal device is in a sleeping mode.

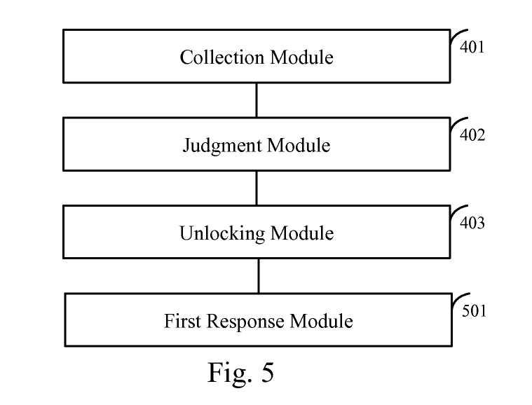

In one embodiment, as shown in FIG. 5, the apparatus may further include a first response module 501.

The first response module 501 is configured to, when the terminal device is held by the user and a touch event occurs on the touch screen of the terminal device, respond to the touch event.

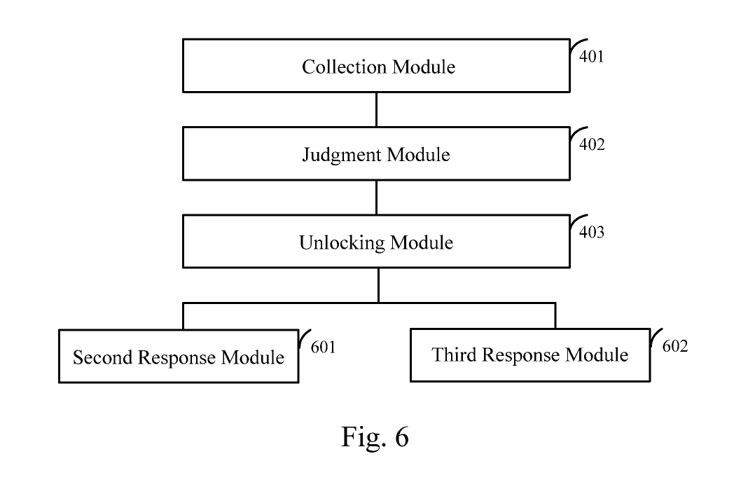

In one embodiment, as shown in FIG. 6, the apparatus may further include a second response module 601 and a third response module 602.

The second response module 601 is configured to, when the terminal device is held by the user and a touch event occurs on the touch screen of the terminal device, respond to the touch event by using a first touch event response threshold.

The third response module 602 is configured to, when the terminal device is not held by the user and a touch event occurs on the touch screen of the terminal device, respond to the touch event by using a second touch event response threshold.

The first touch event response threshold is greater than the second touch event response threshold.

In one embodiment, the judgment module may include a first judgment submodule and a first determination submodule.

The first judgment submodule is configured to judge whether a first signal and a second signal are collected at one side edge of the touch screen of the terminal device and at least a third signal is collected at the other side edge of the touch screen of the terminal device, wherein the first signal is greater than the second signal, and the first signal is greater than the third signal.

The first determination submodule is configured to, if the first, second and third signals are collected, determine that the terminal device is held by a user.

In one embodiment, the judgment module may include a second judgment submodule.

The second judgment submodule is configured to judge whether the terminal device is held by left hand or right hand of the user according to the collected signal.

The unlocking module may include an unlocking submodule.

The unlocking submodule is configured to unlock the terminal device when the terminal device is held by left or right hand of the user and the terminal device is in a sleeping mode.

The embodiments of the present disclosure may include the following advantageous effects: signals at edges of the touch screen of the terminal device are collected, whether the terminal device is held by the user is judged according to the collected signals, and when the terminal device is held by the user and the terminal device is in the sleeping state, the terminal device is unlocked; in this way, the user can unlock the terminal device after holding the terminal device, thereby the convenience and the intelligence of unlocking by the user are improved.

A terminal device includes any of the above-described apparatuses, a touch screen and a sensor, wherein the sensor is located at an edge of the touch screen of the terminal device.

In one embodiment, the terminal device further includes a shielding layer which is located between the sensor and a display screen of the terminal device.

For instance, in the present disclosure, a self-containing solution is adopted at an edge area of the touch screen, thereby a high signal to noise ratio (SNR) can be provided; and signals are collected from multiple channels, thereby the signals of holding the edge by hand are collected. As shown in FIG. 2, a plurality of self-containing sensors are provided at left and right edges of the touch screen. In order to further improve SNR in the edge area, a shielding layer may be further added below these edge self-containing sensors for shielding the noise interference from the below display screen. The need of the shielding layer depends on whether the actual SNR satisfies requirements. Two rectangular shielding layers may be disposed below the self-containing sensors located at the left and right sides, or the shielding layer may be disposed at the entire screen, so as to shield the noise interference from the below display screen.

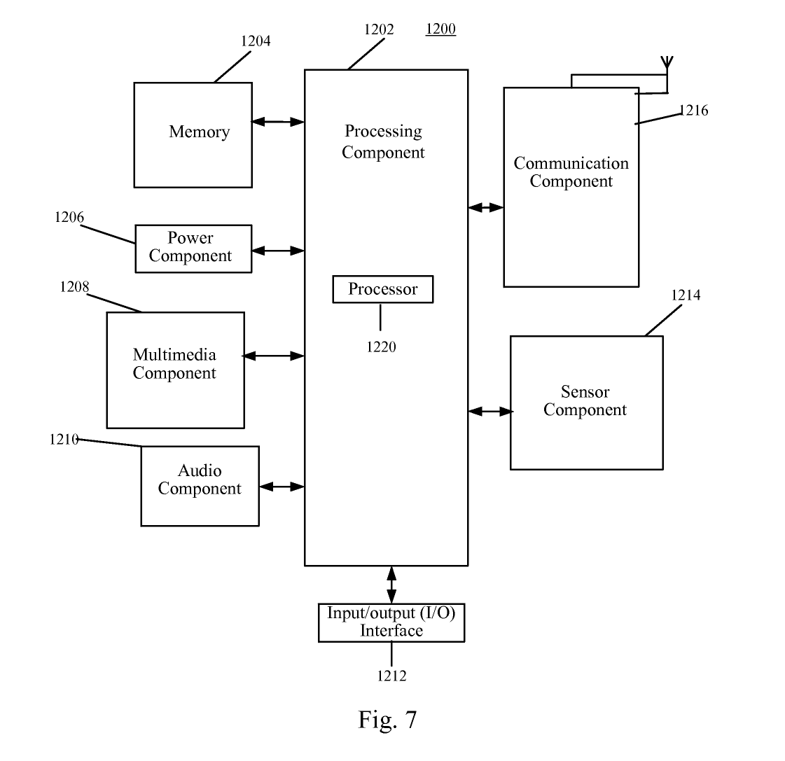

FIG. 7 illustrates a block diagram of a terminal device 1200 using the unlocking method, according to one exemplary embodiment. For example, the terminal device 1200 may be a mobile phone, a computer, a digital broadcast terminal device, a messaging device, a gaming console, a tablet, a medical device, exercise equipment, a personal digital assistant, and the like.

Referring to FIG. 7, the terminal device 1200 may include one or more of the following components: a processing component 1202, a memory 1204, a power component 1206, a multimedia component 1208, an audio component 1210, an input/output (I/O) interface 1212, a sensor component 1214, and a communication component 1216.

The processing component 1202 typically controls overall operations of the terminal device 1200, such as the operations associated with display, telephone calls, data communications, camera operations, and recording operations. The processing component 1202 may include one or more processors 1220 to execute instructions to perform all or part of the steps in the above described methods. Moreover, the processing component 1202 may include one or more modules which facilitate the interaction between the processing component 1202 and other components. For instance, the processing component 1202 may include a multimedia module to facilitate the interaction between the multimedia component 1208 and the processing component 1202.

The memory 1204 is configured to store various types of data to support the operation of the terminal device 1200. Examples of such data include instructions for any applications or methods operated on the terminal device 1200, contact data, phonebook data, messages, pictures, video, etc. The memory 1204 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1206 provides power to various components of the terminal device 1200. The power component 1206 may include a power management system, one or more power sources, and any other components associated with the generation, management, and distribution of power in the terminal device 1200.

The multimedia component 1208 includes a screen providing an output interface between the terminal device 1200 and the user. In some embodiments, the screen may include a liquid crystal display (LCD) and a touch panel (TP). If the screen includes the TP, the screen may be implemented as a touch screen to receive input signals from the user. The TP includes one or more touch sensors to sense touches, swipes, and gestures on the TP. The touch sensors may not only sense a boundary of a touch or swipe action, but also sense a period of time and a pressure associated with the touch or swipe action. In some embodiments, the multimedia component 1208 includes a front camera and/or a rear camera. The front camera and/or the rear camera may receive an external multimedia datum while the terminal device 1200 is in an operation mode, such as a photographing mode or a video mode. Each of the front camera and the rear camera may be a fixed optical lens system or have focus and optical zoom capability.

The audio component 1210 is configured to output and/or input audio signals. For example, the audio component 1210 includes a microphone (“MIC”) configured to receive an external audio signal when the terminal device 1200 is in an operation mode, such as a call mode, a recording mode, and a voice recognition mode. The received audio signal may be further stored in the memory 1204 or transmitted via the communication component 1216. In some embodiments, the audio component 1210 further includes a speaker to output audio signals.

The I/O interface 1212 provides an interface between the processing component 1202 and peripheral interface modules, such as a keyboard, a click wheel, buttons, and the like. The buttons may include, but are not limited to, a home button, a volume button, a starting button, and a locking button.

The sensor component 1214 includes one or more sensors to provide status assessments of various aspects of the terminal device 1200. For instance, the sensor component 1214 may detect an open/closed status of the terminal device 1200, relative positioning of components, e.g., the display and the keypad, of the terminal device 1200, a change in position of the terminal device 1200 or a component of the terminal device 1200, a presence or absence of user contact with the terminal device 1200, an orientation or an acceleration/deceleration of the terminal device 1200, and a change in temperature of the terminal device 1200. The sensor component 1214 may include a proximity sensor configured to detect the presence of nearby objects without any physical contact. The sensor component 1214 may also include a light sensor, such as a CMOS or CCD image sensor, for use in imaging applications. In some embodiments, the sensor component 1214 may also include an accelerometer sensor, a gyroscope sensor, a magnetic sensor, a pressure sensor, or a temperature sensor.

The communication component 1216 is configured to facilitate communication, wired or wirelessly, between the terminal device 1200 and other devices. The terminal device 1200 can access a wireless network based on a communication standard, such as WiFi, 2G, or 3G, or a combination thereof. In one exemplary embodiment, the communication component 1216 receives a broadcast signal or broadcast associated information from an external broadcast management system via a broadcast channel. In one exemplary embodiment, the communication component 1216 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal device 1200 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as included in the memory 1204, executable by the processor 1220 in the terminal device 1200, for performing the above-described methods. For example, the non-transitory computer-readable storage medium may be a ROM, a RAM, a CD-ROM, a magnetic tape, a floppy disc, an optical data storage device, and the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method for unlocking a terminal device, comprising:
collecting a signal at an edge of a touch screen of the terminal device;
judging whether the terminal device is held by a user according to the collected signal; and
if the terminal device is held by the user and the terminal device is in a sleeping mode, unlocking the terminal device.

2. The method according to claim 1, further comprising:
if the terminal device is held by the user and a touch event is occurred on the touch screen of the terminal device, responding to the touch event.

3. The method according to claim 1, further comprising:
if the terminal device is held by the user and a touch event is occurred on the touch screen of the terminal device, responding to the touch event by using a first touch event response threshold; and
if the terminal device is not held by the user and a touch event is occurred on the touch screen of the terminal device, responding to the touch event by using a second touch event response threshold,
wherein the first touch event response threshold is greater than the second touch event response threshold.

4. The method according to claim 1, wherein judging whether the terminal device is held by the user according to the collected signal comprises:
judging whether a first signal and a second signal are collected at one side edge of the touch screen of the terminal device and at least a third signal is collected at the other side edge of the touch screen of the terminal device, wherein the first signal is greater than the second signal, and the first signal is greater than the third signal; and
if the first, second and third signals are collected, determining that the terminal device is held by the user.

5. The method according to claim 1, wherein judging whether the terminal device is held by the user according to the collected signal comprises:
judging whether the terminal device is held by a left hand or a right hand of the user according to the collected signal.

6. The method according to claim 1, wherein unlocking the terminal device if the terminal device is held by the user and the terminal device is in the sleeping mode comprises:
if the terminal device is held by the left hand or the right hand of the user and the terminal device is in the sleeping mode, unlocking the terminal device.

7. A terminal device, comprising:
a touch screen;
a processor; and
a memory for storing instructions executable by the processor,
wherein the processor is configured to execute instructions for:
collecting a signal at an edge of the touch screen of the terminal device;
judging whether the terminal device is held by a user according to the collected signal; and
if the terminal device is held by the user and the terminal device is in a sleeping mode, unlocking the terminal device.

8. The terminal device according to claim 7, wherein the processor is further configured to execute instructions for:
if the terminal device is held by the user and a touch event is occurred on the touch screen of the terminal device, responding to the touch event.

9. The terminal device according to claim 7, wherein the processor is further configured to execute instructions for:
if the terminal device is held by the user and a touch event is occurred on the touch screen of the terminal device, responding to the touch event by using a first touch event response threshold; and
if the terminal device is not held by the user and a touch event is occurred on the touch screen of the terminal device, responding to the touch event by using a second touch event response threshold,
wherein the first touch event response threshold is greater than the second touch event response threshold.

10. The terminal device according to claim 7, wherein judging whether the terminal device is held by the user according to the collected signal comprises:
judging whether a first signal and a second signal are collected at one side edge of the touch screen of the terminal device and at least a third signal is collected at the other side edge of the touch screen of the terminal device, wherein the first signal is greater than the second signal, and the first signal is greater than the third signal; and
if the first, second and third signals are collected, determining that the terminal device is held by a user.

11. The terminal device according to claim 7, wherein judging whether the terminal device is held by the user according to the collected signal comprises:
judging whether the terminal device is held by a left hand or a right hand of a user according to the collected signal.

12. The terminal device according to claim 7, wherein unlocking the terminal device if the terminal device is held by the user and the terminal device is in the sleeping mode comprises:
if the terminal device is held by the left hand or the right hand of the user and the terminal device is in the sleeping mode, unlocking the terminal device.

13. The terminal device according to claim 7, further comprising a sensor,
wherein the sensor is located at an edge of the touch screen of the terminal device.

14. The terminal device according to claim 13, further comprising a shielding layer, wherein the shielding layer is located between the sensor and a display screen of the terminal device.

15. A non-transitory readable storage medium comprising instructions, executable by a processor in a terminal device, for performing a method of unlocking the terminal device, the method comprising:
collecting a signal at an edge of a touch screen of the terminal device;
judging whether the terminal device is held by a user according to the collected signal; and
if the terminal device is held by the user and the terminal device is in a sleeping mode, unlocking the terminal device.
